(19) United States
(12) Patent Application Publication
(10) Pub. No.: US 2004/0085563 A1
(43) Pub. Date: May 6, 2004

(54) Computer equipment used for printer setting, printer setting method, and computer readable medium

(75) Inventor: Kiyotaka Nishimura, Nagano-ken (JP)

Correspondence Address: SUGHRUE MION, PLLC, 2100 Pennsylvania Avenue, NW., Washington, DC, 20037-3213, US

(73) Assignee: SEIKO EPSON CORPORATION

(21) Appl. No.: 10/417,353

(22) Filed: Apr. 17, 2003

(30) Foreign Application Priority Data
Apr. 19, 2002 (JP) 2002-117879(P)
Apr. 19, 2002 (JP) 2002-117899(P)

(51) Int. Cl. G06F 3/12; G06F 15/00; G06F 13/10

(52) U.S. Cl. 358/1.13; 719/321; 719/328

(57) ABSTRACT

An individual setting dialog box DB2 for printer properties, which is open at the time of printing a document according to an application program, has a ‘Reset to Default’ button BT1. In response to a click of this button BT1, entries in input boxes of the individual setting dialog box DB2 are restored to settings of various pieces of information read from a setting information storage data file Dev. The setting information storage data file Dev is specified through activation of printer properties executed by the operating system. The operator may specify desired settings, for example, frequently used settings, for the contents of the data file Dev. This arrangement enables the current settings of printer properties to be restored to the operator's desired settings by a simple click of the button BT1.

The ‘Reset to Default’ button BT1 may be replaced with a ‘Register into Default’ button. In response to a click of this button, the setting information storage data file Dev is updated with entries of setting information on the individual setting dialog box. The setting information storage data file Dev is updated by activation of printer properties starting from a click of a ‘Start’ button of the operating system, and is applied to all the documents to be printed with an object printer. This arrangement enables the desired printer settings at the time of printing a certain document to be readily applied to printing of other documents by a simple operation.

### BACKGROUND OF THE INVENTION

1. Field of the Invention

The present invention relates to a technique of carrying out printer setting with a computer.

2. Description of the Related Art

When print data created by a computer are printed with a printer connecting with the computer, it is required to incorporate software called a printer driver, which is provided for each type of the printer, into the computer. The printer driver is used to set various pieces of printing-related information, such as the paper used for printing and the print object, in the computer. This process is called ‘setting of the printer’. The setting of the printer makes the printer ready for actual printing.

The setting of the printer (hereafter simply be referred to as ‘printer setting’) is implemented through a series of operations by the operator discussed below. The following description regards a computer with Windows 98 (registered trademark by Microsoft Co., Ltd.) incorporated therein. The operator clicks a ‘Start’ button, points an option ‘Settings’, and subsequently clicks an option ‘Printer’ to open a ‘Printer’ folder. The operator then right clicks an icon of a printer used for printing among icons displayed in the ‘Printer’ folder to open a window for printer properties. This window is provided by the printer driver and includes input boxes with regard to various pieces of information, for example, the paper type, the paper size, and the printing orientation. The operator inputs data in these input boxes through operations of a keyboard and a mouse to set the various pieces of information in the computer. The window for printer properties may alternatively be opened from a ‘Print’ dialog box, which is displayed in the printing process according to a working application program.

In one prior art structure, the window for printer properties has a reset button for restoring the current printer settings modified by the operator to the original settings. When the operator clicks the reset button, default data specified by the supplier of the printer driver at the time of shipment are entered in the input boxes of the window for printer properties. This operation clears all the modified printer settings and enables the operator to renew the printer setting all over again.

The above prior art technique, however, simply restores the current printer settings to the original settings at the time of shipment, but does not allow for restoration to the operator's desired settings. The operator generally specifies the printer settings for some purposes. When the specified printer settings are significantly different from the original settings at the time of shipment, the operator is required to input desired data in multiple input boxes again after restoration to the original settings at the time of shipment.

There is another problem.

There are two methods available for the printer setting as described above. One method starts from a click of the ‘Start’ button to open the window for printer properties. The other method opens the window for printer properties from the ‘Print’ dialog box, which is displayed in the printing process according to the working application program. The printer setting by the former method is hereafter called ‘default setting’.

The default setting is applied to all the documents to be printed with the printer. The latter method is applied to change the printer setting with regard to only a specified document. According to the concrete procedure of the latter method, the operator clicks a menu ‘File’ on the working application program and subsequently clicks an option ‘Print’ to open the ‘Print’ dialog box. The operator then clicks a ‘Properties’ button on this dialog box to open a window for printer properties. This window is substantially similar to the window for printer properties opened for default setting. The respective input boxes of this window are filled in advance with entries of the default setting. The operator rewrites the entries in only desired input boxes, so as to modify the printer settings and enable a specific document to be printed under the desired printer settings.

The prior art technique, however, causes the current printer settings modified at the time of printing a certain document to be applied only for the certain document, and does not allow the modified printer settings to be applied to other documents after the application program is terminated. (Some application programs do not have the record of the modification even for the certain document.) In the case where the modified printer settings at the time of printing the certain document are desirable and suitable for other documents, the operator is required to note the modified printer settings and change the default setting based on the note. Namely the prior art technique has poor workability in the case of application of desired printer settings specified at the time of printing a certain document to printing of other documents.

### SUMMARY OF THE INVENTION

The object of the present invention is thus to enable current printer settings to be readily restored to the operator's desired settings by a simple operation and also to enable desired printer settings at the time of printing a certain document to be readily applied to printing of other documents by a simple action.

The present invention is constructed as discussed below to attain at least part of the above and the other related objects.

The present invention is directed to a first computer apparatus for printer setting. The computer apparatus connects with a display device, a printer, and an input device manipulated by an operator and has an operating system and an application program incorporated therein. The computer apparatus includes: a printer setting module that sets various pieces of information required for printing with the printer and stores settings of the various pieces of information in a predetermined data file, according to the operating system; and a print control module that reads the settings of the various pieces of information from the predetermined data file as execution information and causes the printer to execute a printing operation based on the execution information, according to the application program.

The print control module includes: a data input window display module that, in response to a given operation of the input device, displays a data input window, which includes multiple input boxes corresponding to the various pieces of information, with preset entries of default data in the respective input boxes on the display device; an input reception module that enters data input from the input device into at least one of the input boxes of the data input window; a printer settings change module that modifies the execution information, based on the data entered into at least one of the input boxes of the data input window; a specific operation reception module that receives a specific operation of the input device on the data input window; and an input box restoration module that, when the specific operation reception module receives the specific operation, enters data based on the settings of the various pieces of information read from the predetermined data file, into the input boxes of the data input window.

Here the input boxes include input fields, radio buttons, check boxes, and any other forms of input boxes that can receive the operator's manipulations and operations.

When the operator enters data in the input boxes of the data input window at the time of printing a document according to the application program, the computer apparatus of the above construction modifies the settings of the various pieces of information specified by the operating system and stored in the predetermined data file and causes the printer to carry out a printing operation based on the modified pieces of information. When the specific operation reception module receives the specific operation of the input device on the data input window, the input box restoration module restores the settings in the input boxes of the data input window to the entries of data based on the various pieces of information read from the predetermined data file.

The operator may specify desired settings, for example, frequently used settings, for the contents of the predetermined data file set by the operating system. This arrangement enables current settings to be readily restored to the operator's desired settings by a simple operation, that is, in response to the specific operation on the data input window.

In one preferable application of the first computer apparatus described above, the specific operation reception module receives a click of a preset button provided on the data input window.

The computer apparatus of this application enables the current settings to be readily restored to the operator's desired settings by a simple click of the button.

In another preferable application of the first computer apparatus, the default data preset in the multiple input boxes of the data input window are data based on the settings of the various pieces of information read from the predetermined data file.

The computer apparatus of this application enters the contents of the predetermined data file set by the operating system in the input boxes of the data input window, which is opened in response to the given operation of the input device, at the time of printing a document according to the application program.

The present invention is also directed to a second computer apparatus for printer setting. The computer apparatus connects with a display device, a printer, and an input device manipulated by an operator and has an operating system and an application program incorporated therein. The computer apparatus includes: a default setting module that sets various pieces of information required for printing with the printer and stores settings of the various pieces of information in a predetermined data file, according to the operating system; and a print control module that reads the settings of the various pieces of information from the predetermined data file and causes the printer to execute a printing operation based on the read-out pieces of information, according to the application program.

The print control module includes: an input data reception module that, in response to a given operation of the input device, displays a data input window on the display device to receive input data from the input device on the data input window; a settings change module that modifies the settings of the various pieces of information read from the predetermined data file, based on the input data received by the input data reception module, so as to change over printing conditions; a specific operation reception module that receives a specific operation of the input device on the data input window; and a data file update module that, when the specific operation reception module receives the specific operation, updates the predetermined data file, based on the input data received by the input data reception module.

In the second computer apparatus of the above construction, at the time of printing a document according to the application program, in response to the given operation of the input device, the input data reception module displays the data input window on the display device to receive input data from the input device on the data input window. The settings change module modifies the settings of the various pieces of information read from the predetermined data file, based on the received input data, so as to change over printing conditions. When the specific operation reception module receives the specific operation of the input device on the data input window, the data file update module updates the predetermined data file, based on the input data received by the input data reception module.

The operator manipulates the input device to give the specific operation at the time of entry into the data input window in the printing process. The predetermined data file obtained by the default settings is thus updatable with the various pieces of information modified based on the input data on the data input window. This arrangement effectively enables the desired printer settings at the time of printing a certain document to be applied to printing of other documents by a simple operation.

In one preferable application of the second computer apparatus described above, the specific operation reception module receives a click of a preset button provided on the data input window.

The second computer apparatus of this application enables the desired printer settings at the time of printing a certain document to be applied to printing of other documents by a simple click of the button.

The present invention is also directed to a first print control method that is related to series of processing according to an application program and an operating system that controls at least operations of a display device, a printer, and an input device manipulated by an operator. The print control method thereby causes the printer to carry out a printing operation. The print control method includes the steps of: (a) setting various pieces of information required for printing with the printer and storing settings of the various pieces of information in a predetermined data file, according to the operating system; and (b) reading the settings of the various pieces of information from the predetermined data file as execution information and causing the printer to execute a printing operation based on the execution information, according to the application program.

The step (b) includes the steps of: (b-1) in response to a given operation of the input device, displaying a data input window, which includes multiple input boxes corresponding to the various pieces of information, with preset entries of default data in the respective input boxes on the display device; (b-2) entering data input from the input device into at least one of the input boxes of the data input window; (b-3) modifying the execution information, based on the data entered into at least one of the input boxes of the data input window; (b-4) receiving a specific operation of the input device on the data input window; and (b-5) when the specific operation is received in the step (b-4), entering data based on the settings of the various pieces of information read from the predetermined data file, into the input boxes of the data input window.

The present invention is further directed to a first computer readable medium, in which a program command is stored. The program command is related to series of processing according to an application program and an operating system that controls at least operations of a display device, a printer, and an input device manipulated by an operator. The program command thereby controlls the printer. The program command includes: a first program command that sets various pieces of information required for printing with the printer and stores settings of the various pieces of information in a predetermined data file, according to the operating system; and a second program command that reads the settings of the various pieces of information from the predetermined data file as execution information and causes the printer to execute a printing operation based on the execution information, according to the application program.

The second program command includes: a third program command that display module that, in response to a given operation of the input device, displays a data input window, which includes multiple input boxes corresponding to the various pieces of information, with preset entries of default data in the respective input boxes on the display device; a fourth program command that enters data input from the input device into at least one of the input boxes of the data input window; a fifth program command that modifies the execution information, based on the data entered into at least one of the input boxes of the data input window; a sixth program command that receives a specific operation of the input device on the data input window; and a seventh program command that, when the sixth program command receives the specific operation, enters data based on the settings of the various pieces of information read from the predetermined data file, into the input boxes of the data input window.

The first print control method and the first computer readable medium have the similar functions and effects to those of the first computer apparatus described above, and enable current printer settings to be readily restored to the operator's desired settings by a simple operation.

The present invention is also directed to a second print control method that is related to series of processing according to an application program and an operating system that controls at least operations of a display device, a printer, and an input device manipulated by an operator. The print control method thereby causes the printer to carry out a printing operation. The print control method includes the steps of: (a) setting various pieces of information required for printing with the printer and storing settings of the various pieces of information in a predetermined data file, according to the operating system; and (b) reading the settings of the various pieces of information from the predetermined data file and causing the printer to execute a printing operation based on the read-out pieces of information, according to the application program.

The step (b) includes the steps of: (b-1) in response to a given operation of the input device, displaying a data input window on the display device to receive input data from the input device on the data input window; (b-2) modifying the settings of the various pieces of information read from the predetermined data file, based on the input data received in the step (b-1), so as to change over printing conditions; (b-3) receiving a specific operation of the input device on the data input window; and (b-4) when the specific operation is received in the step (b-3), updating the predetermined data file, based on the input data received in the step (b-1).

The present invention is further directed to a second computer readable medium, in which a program command is stored. The program command is related to series of processing according to an application program and an operating system that controls at least operations of a display device, a printer, and an input device manipulated by an operator. The program command thereby controlls the printer. The program command includes: a first program command that sets various pieces of information required for printing with the printer and stores settings of the various pieces of information in a predetermined data file, according to the operating system; and a second program command that reads the settings of the various pieces of information from the predetermined data file and causes the printer to execute a printing operation based on the read-out pieces of information, according to the application program.

The second program command (b) includes: a third program command that, in response to a given operation of the input device, displays a data input window on the display device to receive input data from the input device on the data input window; a fourth program command that modifies the settings of the various pieces of information read from the predetermined data file, based on the input data received by the first program command (b-1), so as to change over printing conditions; a fifth program command that receives a specific operation of the input device on the data input window; and a sixth program command that, when the fifth program command receives the specific operation, updates the predetermined data file, based on the input data received by the third program command.

The second print control method and the second computer readable medium have the similar functions and effects to those of the second computer apparatus described above, and enable the desired printer settings at the time of printing a certain document to be applied to printing of other documents by a simple operation.

The technique of the present invention may be attained by computer programs corresponding to the first and the second computer readable media described above, where each computer program includes multiple program commands and is stored in the corresponding computer readable medium. Another application is a program supply device that supplies such computer programs via a communication path. In the application of the program supply device, the computer programs are located on a server of a computer network. A required program is downloaded to a computer via the communication path and is executed by the computer to attain any of the computer apparatuses and the methods described above.

### BRIEF DESCRIPTION OF THE DRAWINGS

FIG. 1 is a block diagram schematically illustrating the hardware construction of a computer system 10 in a first embodiment of the present invention;

FIG. 2 is a block diagram showing a series of processing to print an image based on image information processed by a computer main body 16;

FIG. 3 shows a default setting dialog box DB1 for printer properties;

FIG. 4 shows an individual setting dialog box DB2 for printer properties;

FIG. 5 is a flowchart showing a control routine executed according to a printer driver 53;

FIG. 6 is a flowchart showing the details of a default setting routine executed at step S120;

FIG. 7 shows one example of the data structure of a setting information storage data file Dev;

FIG. 8 is a flowchart showing a first half of an individual setting routine executed at step S140;

FIG. 9 is a flowchart showing a latter half of the individual setting routine;

FIG. 10 is a block diagram showing a series of processing to print an image based on image information processed by the computer main body 16 in a second embodiment of the invention;

FIG. 11 shows an individual setting dialog box DB52 for printer properties;

FIG. 12 is a flowchart showing a print control routine executed by a CPU 30;

FIG. 13 is a flowchart showing the details of a default setting routine executed at step S620;

FIG. 14 is a flowchart showing the details of an individual setting routine executed at step S640; and

FIG. 15 schematically shows the processing of step S730.

### DESCRIPTION OF THE PREFERRED EMBODIMENTS

Some modes of the present invention are discussed below as preferred embodiments in the following sequence:

1. First Embodiment

A. Construction of System

B. Computer Processing

C. Functions and Effects

D. Modifications

2. Second Embodiment

E. Construction of System

F. Computer Processing

G. Functions and Effects

H. Modifications

A. Construction of System

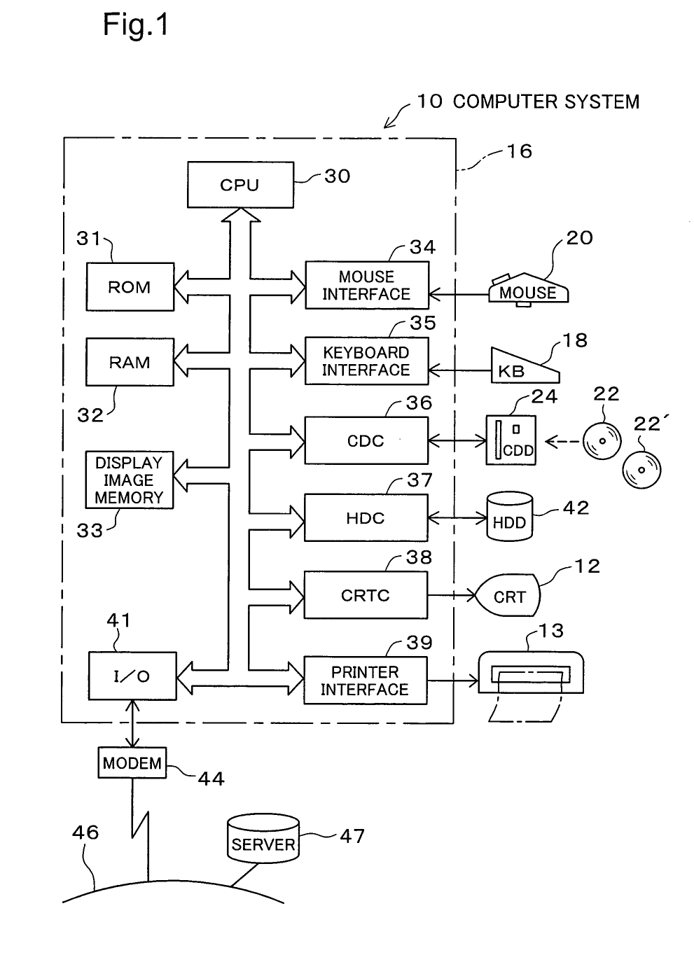

FIG. 1 is a block diagram schematically illustrating the hardware construction of a computer system 10 in a first embodiment of the present invention. This computer system 10 includes a personal computer (hereafter simply referred to as computer) as its center, and a CRT display (hereafter simply referred to as display) 12 and a printer 13 as peripheral equipment. The computer has a computer main body 16, a keyboard 18, and a mouse 20. A CD drive 24 that functions to read the contents of a CD-ROM 22 is mounted on the computer main body 16. The printer 13 is an ink-jet printer that ejects ink droplets to create dots on the surface of paper. The printer 13 moves a carriage back and forth in a main scanning direction, while feeding paper in a sub-scanning direction, so as to record an image on the paper.

The computer main body 16 has a central processing unit or CPU 30 as its center, as well as a ROM 31, a RAM 32, a display image memory 33, a mouse interface 34, a keyboard interface 35, a CDC 36, an HDC 37, a CRTC 38, a printer interface 39, and an I/O port 41 mutually connecting via a bus. The ROM 31 is a read only memory to store a diversity of internal programs therein. The RAM 32 is a readable and writable memory to store various data therein. The display image memory 33 stores image data representing images to be displayed on the display 12.

The mouse interface 34 takes charge of data transmission to and from the mouse 20. The keyboard interface 35 takes charge of key inputs from the keyboard 18. The CDC 36 is a CD controller that controls the CD drive (CDD) 24. The HDC 37 is a hard disk controller that controls a hard disk drive (HDD) 42. Computer programs discussed below are stored in advance in the HDD 42.

The CRTC 38 is a CRT controller that controls display of images on the display 12, based on the display image data stored in the display image memory 33. The printer interface 39 controls input and output of data from and to the printer 13. The I/O port 41 has a serial output port and is connected to the modem 44 and further to a public telephone network 46 via the modem 44. The computer main body 16 is connected to an external network via the modem 44 to be accessible to a specific server 47.

In this computer system 10, an operating system (for example, Windows 98) is stored in the HDD 42. With a supply of electric power to the computer main body 16, the operating system is loaded into a predetermined area of the RAM 32 according to a loader written in a boot block of the HDD 42. A printer driver provided for each type of the printer 13 is stored in advance in the CD-ROM 22 and is installed via the CD drive 24 into the computer main body 16 in response to activation of a preset installation program. The installed printer driver is stored in the HDD 41. With a supply of electric power to the computer main body 16, the printer driver is incorporated in the operating system and is loaded into a preset area of the RAM 32.

An application program, photo retouching software (for example, Adobe Photoshop, which is the registered trademark of Adobe Systems Inc.) is incorporated in the computer system 10. The photo retouching software is stored in advance in a CD-ROM 22′ and is installed via the CD drive 24 into the computer main body 16 in response to activation of a preset installation program. This installed computer program is stored in the HDD 42 and is loaded into a preset area of the RAM 32 in response to a predetermined activation instruction.

The CPU 30 executes the printer driver to actualize some constituents of the present invention. The printer driver is stored in the CD-ROM 22 in the structure of this embodiment, but may alternatively be stored in another portable recording medium (transportable recording medium), such as a floppy disk, a magneto-optic disk, or an IC card. The computer program may be obtained by downloading program data from the specific server 47 via the external network and transferring the downloaded program data to the RAM 32 or the HDD 42. The network may be the Internet, and the computer program may be downloaded from a specified home page. The computer program may otherwise be supplied in the form of an attached file of an e-mail.

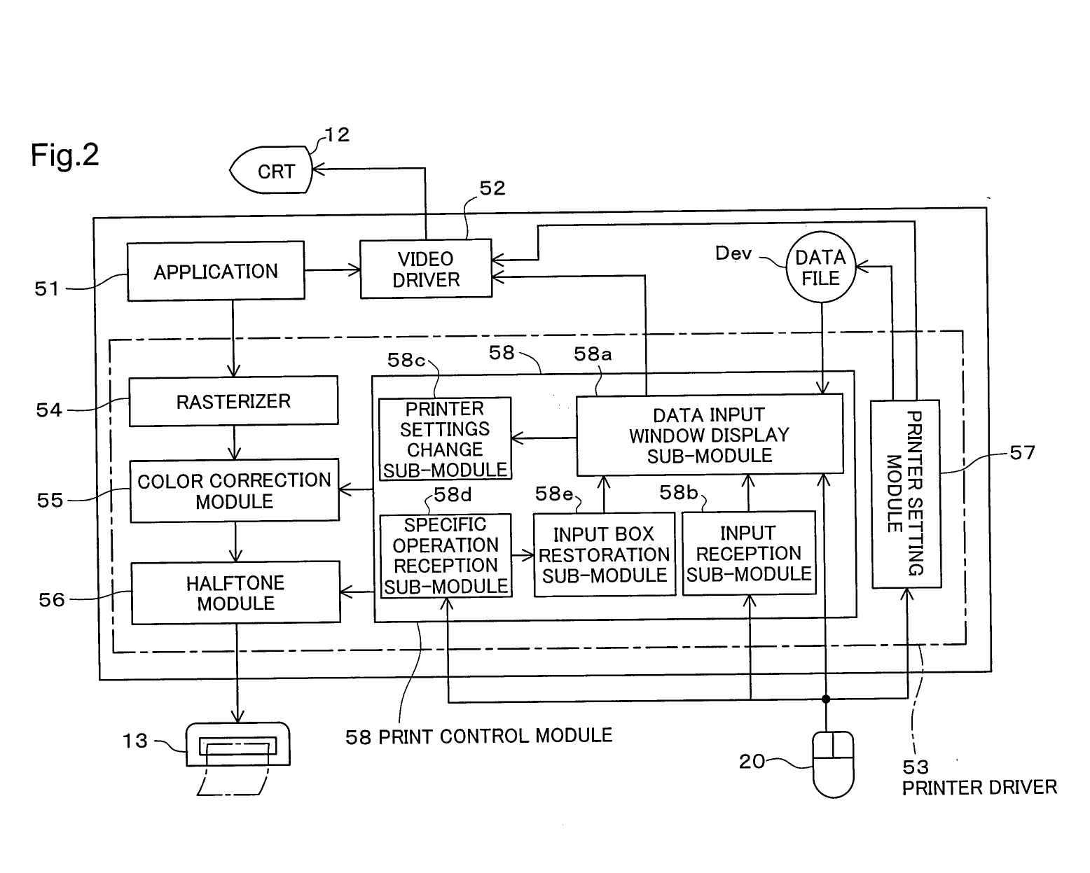

The following describes a printing procedure by the computer system 10 having the hardware construction described above. FIG. 2 is a block diagram showing a series of processing to print an image based on image information processed by the computer main body 16. As illustrated, an application program 51 running in the computer main body 16 carries out a required series of image processing and displays each processed image on the display 12 via a video driver 52. When the application program 51 issues a print command, a printer driver 53 in the computer main body 16 receives image data from the application program 51 and converts the input image data into signals printable by the printer 13.

In the illustrated example of FIG. 2, the printer driver 53 includes a rasterizer 54 that converts the image data processed by the application program 51 into color information of a dot unit, a color correction module 55 that makes the image data converted into the color information of the dot unit (tone data) subjected to color correction according to the color characteristics of the printer 13, and a halftone module 56 that generates halftone image information, which expresses a density in a certain area by the presence or absence of ink dots based on the color-corrected image data.

The printer driver 53 also has a printer setting module 57, which presets various pieces of information required for printing by the printer 13 and stores the variety of preset pieces of information in a data file (a setting information storage data file discussed later) Dev. The printer setting module 57 displays a window via the video driver 52 in response to a given operation on the operating system, and carries out setting of the various pieces of information based on output signals from the mouse 20. The various pieces of information required for printing include the printing quality, the color correction, the process of halftoning, the type and the size of paper, and the printing orientation.

The printer driver 53 further includes a print control module 58. The print control module 58 reads the various pieces of information, which have been stored previously in the data file Dev by the printer setting module 57, from the data file Dev as execution information in response to a given operation on the application program and causes the printer 13 to execute a printing operation based on the execution information. According to a concrete procedure, information on the color correction included in the execution information is sent to the color correction module 55, whereas information on the process of halftoning is sent to the halftone module 56.

The print control module 58 includes a data input window display sub-module 58a, an input reception sub-module 58b, a printer settings change sub-module 58c, a specific operation reception sub-module 58d, and an input box restoration sub-module 58e. The functions of the respective sub-modules 58a through 58e will be discussed later.

The printer driver 53 can perform two different procedures of printer setting, that is, default setting applied to all the documents to be printed by the printer 13 and individual setting applied to only a document to be printed at the time of printing. The default setting is implemented by the printer setting module 57 according to the following series of operations. Here it is assumed that the operating system is Windows 98. The operator first clicks a ‘Start’ button on the screen of the display 12, points an option ‘Settings’, and subsequently clicks an option ‘Printer’ to open a ‘Printer’ folder. The operator then right clicks an icon of the printer 13 used for printing among icons displayed in the ‘Printer’ folder to open a dialog box for printer properties (hereafter referred to as default setting dialog box). The ‘Printer’ folder may alternatively be opened by click operations of an icon ‘My Computer’ and the option ‘Printer’.

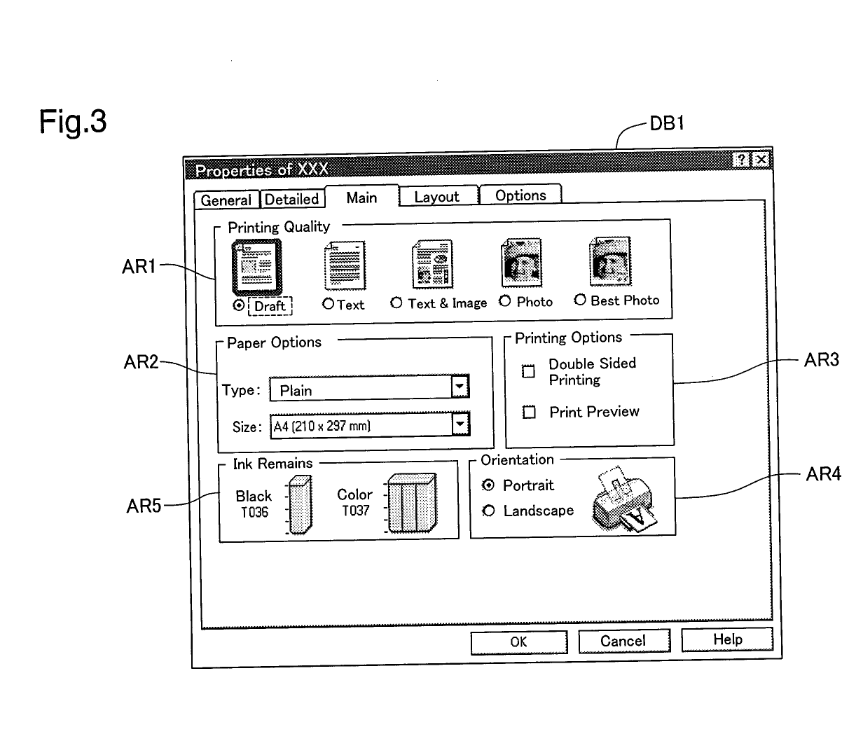

FIG. 3 shows a default setting dialog box DB1 for printer properties. As illustrated, the default setting dialog box DB1 has five tabs ‘General’, ‘Detailed’, ‘Main’, ‘Layout’, and ‘Options’. The ‘General’ tab is opened to set general information regarding the printer, for example, comments of the printer. The ‘Detailed’ tab is opened to set detailed information regarding the printer, for example, ports connecting with the printer. The ‘Main’ tab is opened to set fundamental pieces of information regarding the printing quality and the paper. The ‘Layout’ tab is opened to set various pieces of information regarding the layout of printing. The ‘Options’ tab is opened to set other useful pieces of information.

The ‘General’ tab and the ‘Detailed’ tab do not depend upon the type of the printer, while the ‘Main’ tab and the other tabs depend upon the type of the printer. The operator selects one of these tabs through an operation of the mouse 20 to open the selected tab in the default setting dialog box DB1.

In the illustrated example of FIG. 3, the ‘Main’ tab is open. As illustrated, this ‘Main’ tab includes four input areas AR1, AR2, AR3, and AR4 ‘Printing Quality’, ‘Paper Options’, ‘Print Options’, and ‘Orientation’ and one output area AR5 ‘Ink Remains’. The input area AR1 ‘Printing Quality’ specifies the printing quality and has five radio buttons ‘Draft’, ‘Text’, ‘Text & Image’, ‘Photo’, and ‘Best Photo’.

The input area AR2 ‘Paper Options’ includes a ‘Type’ input field for setting the type of the paper and a ‘Size’ input field for setting the size of the paper. There are various options, for example, ‘Plain’, ‘Super Fine’, and ‘Glossy Photo’, provided for the ‘Type’ input field. There are various options, for example, ‘A4 210×297 mm’, ‘A4 Lateral 210×297 mm’, ‘Envelope 120×235 mm’, and ‘Postcard 100×147 mm’, provided for the ‘Size’ input field. The ‘Printing Options’ input area AR3 has a check box for specifying double sided printing and a check box for setting the requirement or non-requirement of print preview. The ‘Orientation’ input area AR4 specifies the printing orientation of the paper and has two radio buttons ‘Portrait’ and ‘Landscape’. The ‘Ink Remains’ output area AR5 have meters showing the remaining quantities of black and color inks.

The other tabs ‘Layout’ and ‘Options’ are not specifically described here. The operator inputs data in the respective input fields, radio buttons, and check boxes in the open ‘Main’ tab and other tabs through operations of the mouse 20 (and the keyboard 18 when necessary). This default setting dialog box DB1 is displayed by the function of the printer setting module 57. Hereafter the input fields, the radio buttons, and the check boxes are generically called input boxes.

The other procedure of printer setting, the individual setting, is implemented according to the following series of operations. Here it is assumed that the photo retouching software is used as the application program to print a processed image. The operator clicks an option ‘Files’ on a menu bar of an application window and subsequently clicks an option ‘Print’ to open a ‘Print’ dialog box. The operator then clicks an ‘Properties’ button in the ‘Printer’ dialog box to open a dialog box for printer properties (this corresponds to the data input window of the present invention and is hereafter referred to as individual setting dialog box).

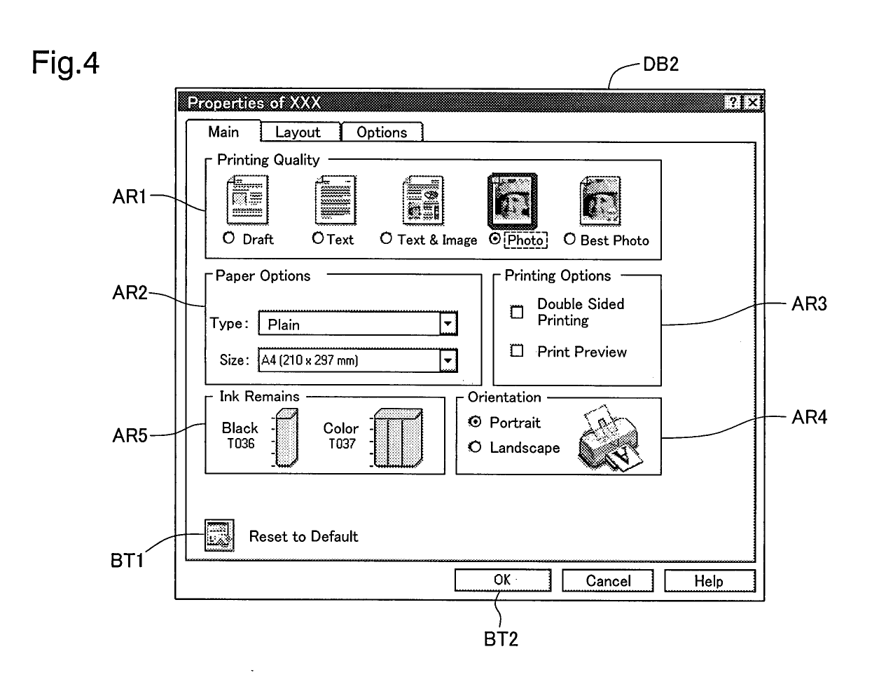

FIG. 4 shows an individual setting dialog box DB2 for printer properties. As illustrated, the individual setting dialog box DB2 has three tabs ‘Main’, ‘Layout’, and ‘Options’. These tabs ‘Main’, ‘Layout’, and ‘Options’ are similar to those of the default setting dialog box DB1 described previously. The only difference is that the individual setting dialog box DB2 has a ‘Reset to Default’ button BT1 on the bottom of the ‘Main’ tab, as shown in FIG. 4. A series of processing executed in response to a click of the ‘Reset to Default’ button BT1 will be discussed later. The operator inputs data in the respective input boxes on the respective tabs included in the individual setting dialog box DB2 through operations of the mouse 20 (and the keyboard 18 when necessary). This individual setting dialog box DB2 is displayed by the function of the data input window display sub-module 58a included in the print control module 58. The input reception sub-module 58b functions to enter the input data through the operations of the mouse 20 and the keyboard 18 in the respective input boxes of the individual setting dialog box DB2.

B. Computer Processing

The CPU 30 of the computer main body 16 executes the printer driver 53 to actualize the respective modules 54 through 58. A control routine executed according to the printer driver 53 is discussed below.

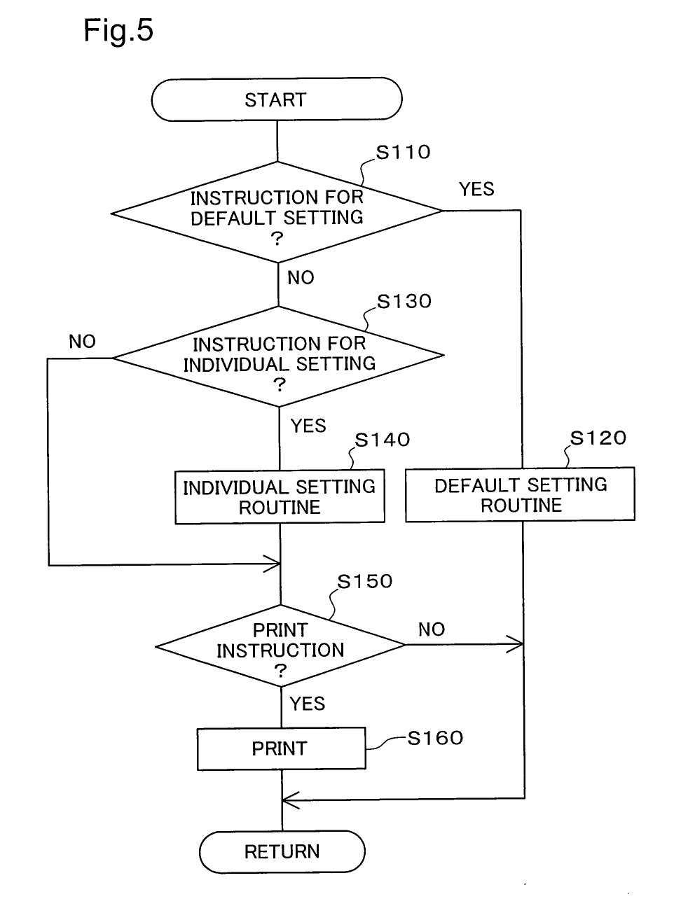

FIG. 5 is a flowchart showing the control routine executed according to the printer driver 53. This control routine is repeatedly executed at preset time intervals. When this control routine starts, the CPU 30 first determines whether or not there is input of an instruction for default setting (that is, activation of the printer properties starting from a click of the ‘Start’ button as described previously) (step S110). This instruction is input from the operating system. In the case of an affirmative answer, a default setting routine is activated (step S120).

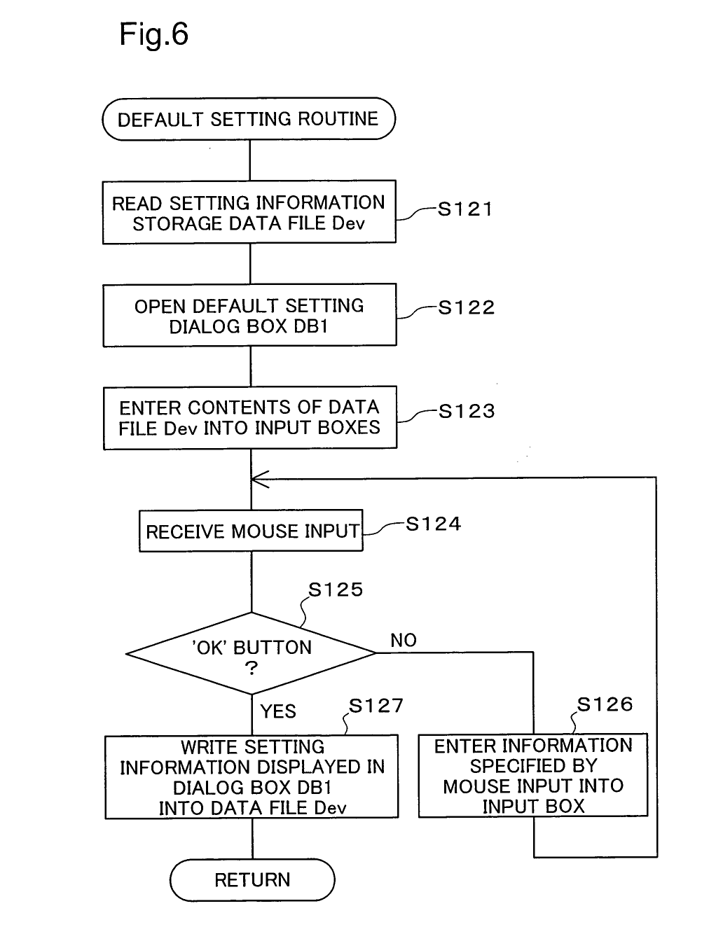

FIG. 6 is a flowchart showing the details of the default setting routine executed at step S120. The series of processing executed by the CPU 30 according to this default setting routine corresponds to the printer setting module 57 (see FIG. 2) discussed previously. When the default setting routine starts, the CPU 30 first reads the setting information storage data file Dev stored in the RAM 32 (step S121). The setting information storage data file Dev is included in a registry stored in the operating system. In the case of Windows 98, this data file Dev corresponds to a file ‘¥PrintersY<Printer Name>¥Default Dev Mode’. The setting information storage data file Dev initially has storage of setting information as the basis provided in advance at the time of installation of the printer driver and is updated by a later step of the default setting routine. Like the printer driver, the setting information storage data file Dev is loaded from the HDD 42 into a predetermined area of the RAM 32 in response to activation of the operating system, and is saved from the RAM 32 into the HDD 42 in response to termination of the operating system.

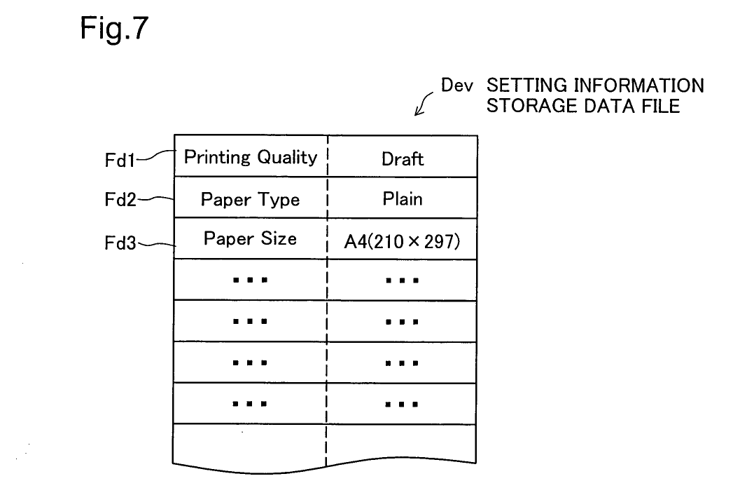

FIG. 7 shows one example of the data structure of the setting information storage data file Dev. As illustrated, the setting information storage data file Dev has data fields Fd1, Fd2, Fd3, . . . to store various pieces of setting information, for example, ‘Printing Quality’, ‘Paper Type’, and ‘Paper Size’. The respective data fields Fd1, Fd2, Fd3, . . . correspond to data items enterable from the respective input boxes included in the default setting dialog box DB1. The data fields Fd1, Fd2, Fd3, . . . may not be identical with the data items of these input boxes, but may include other pieces of information that can be specified from the entries of the respective input boxes.

Referring back to FIG. 6, the CPU 30 opens the default setting dialog box DB1 on the display 12 (step S122). The CPU 30 subsequently enters the various pieces of setting information, which are stored in the setting information storage data file Dev read at step S121, into blanks of the respective input boxes included in the default setting dialog box DB1 (step S123). As a result of the processing of steps S122 and S123, the default setting dialog box DB1 opened on the display 12 has entries of the setting information, which is stored in the setting information storage data file Dev, in the respective input boxes including the input fields, the radio buttons, and check boxes.

The CPU 30 then receives an input from the mouse 20 on the open default setting dialog box DB1 (step S124), and determines whether or not the mouse input received at step S124 represents a click of an ‘OK’ button BT2 (step S125). In the case of a negative answer, the CPU 30 enters a piece of information specified by the mouse input received at step S124 into the corresponding input box. According to the processing of steps S124 through S126, the CPU 30 receives an instruction input from the mouse 20 for modification of the entry in one of the input boxes included in the default setting dialog box DB1 and enters the modified information (changes the entry) in the input box. After execution of step S126, the CPU 30 goes back to step S124 to receive another mouse input on the default setting dialog box DB1.

In the case of an affirmative answer at step S125, that is, when it is determined that the mouse input received at step S124 represents a click of the ‘OK’ button BT2, on the other hand, the CPU 30 writes the various pieces of setting information, which are displayed in the default setting dialog box DB1, into the setting information storage data file Dev of the RAM 32, so as to update the setting information storage data file Dev at step S127. After execution of step S127, the program goes to ‘Return’ and exits from this default setting routine.

Referring back to FIG. 5, on conclusion of the default setting routine, the program goes to ‘Return’ and exits from the control routine. In the case of a negative answer at step S110, on the other hand, the CPU 30 determines whether or not there is input of an instruction for individual setting (that is, activation of the printer properties on the ‘Print’ dialog box as described previously) at step S130. This instruction is input from the application program via the operating system. In the case of an affirmative answer, an individual setting routine is activated (step S140).

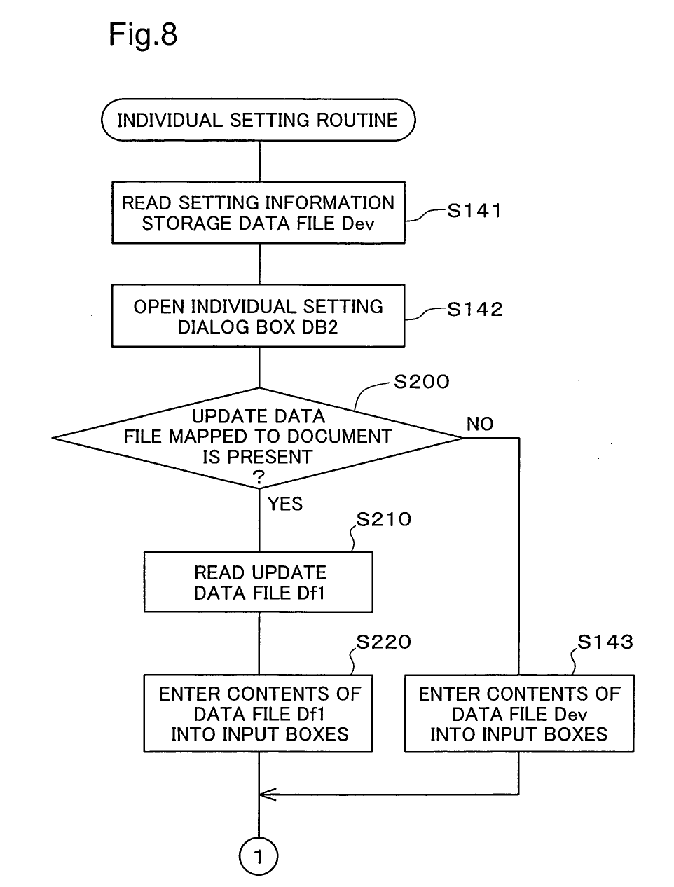

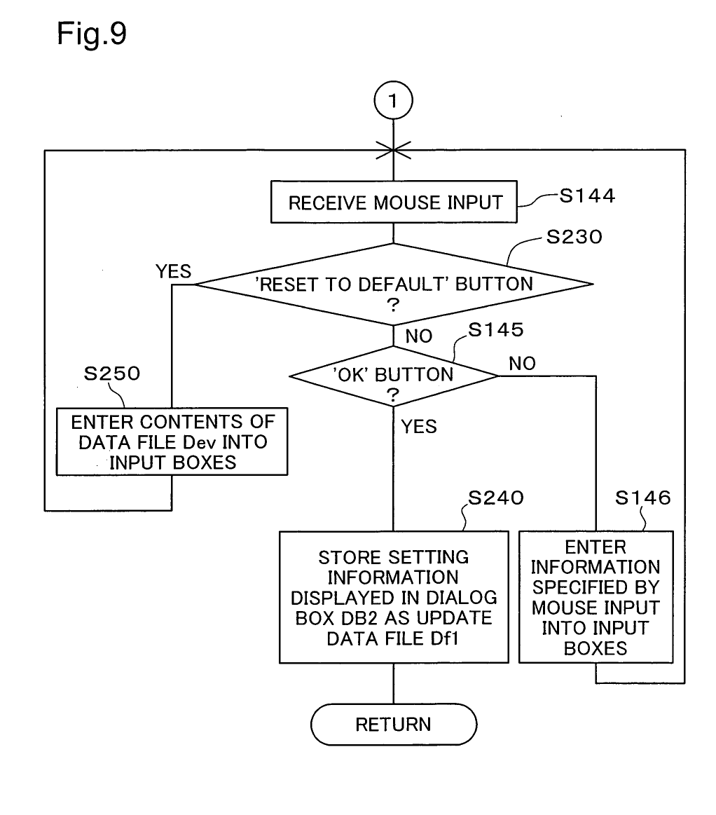

FIGS. 8 and 9 are flowcharts showing the details of the individual setting routine executed at step S140. The individual setting routine executes the processing of steps S141 through S146, which is similar to the processing of steps S121 through S126 of the default setting routine discussed above. The differences of the processing of steps S141 through S146 from the corresponding steps of the default setting routine are that the individual setting dialog box DB2 is open on the display 12, in place of the default setting dialog box DB1, and that the individual setting dialog box DB2 is the object of entries of the setting information stored in the setting information storage data file Dev and the mouse input.

The individual setting has a characteristic series of processing between step S142 and step S143. After execution of step S142, the program goes to step S200, at which the CPU 30 determines the presence or the absence of an update data file Df1 mapped to a document created as a print object by the application program 51. The update data file Df1 has an identical data structure with that of the setting information storage data file Dev and is exclusively provided for each document as the print object. In general, the application programs are divided into relatively high performance programs, which store the pieces of information set according to the individual setting routine as the update data file Df1 and apply the update data file Df1 for printing of the identical document as the print object at subsequent times, and low performance programs, which do not have the update data file Df1 and use the pieces of information set according to the individual setting routine only once for printing of the document this time.

When the application program 51 is a low performance program or when the application program 51 is a high performance program but the current cycle of processing to print the document as the print object is the first time, the processing of step S200 gives a negative answer. Namely it is determined that no mapped update data file Df1 is present. In this case, the CPU 30 enters the various pieces of setting information, which are stored in the setting information storage data file Dev read at step S141, into blanks of the respective input boxes included in the individual setting dialog box DB2 (step S143).

When the application program is a high performance program and the current cycle of processing to print the document as the print object is not the first time, on the other hand, the processing of step S200 gives an affirmative answer. Namely it is determined that the mapped update data file Df1 is present. In this case, the CPU 30 reads the update data file Df1, which is created at a later step and is stored in mapping to the document as the print object from the RAM 32 (step S210) and enters the various pieces of setting information, which are stored in the read-out update data file Df1, into blanks of the respective input boxes included in the individual setting dialog box DB2 (step S220).

After execution of either step S143 or step S220, the program goes to step S144 shown in FIG. 9. The individual setting routine executes a series of characteristic processing in the course of execution of subsequent steps S144 through S146. After execution of step S144, the program goes to step S230, at which the CPU 30 determines whether or not the mouse input received at step S144 represents a click of the ‘Reset to Default’ button BT1 provided on the individual setting dialog box DB2. In the case of a negative answer, the program goes to step S145.

In the same manner as step S125, the processing of step S145 determines whether or not the mouse input received at step S144 represents a click of the ‘OK’ button BT2. In the case of a negative answer, the CPU 30 enters a piece of information specified by the mouse input received at step S144 into the corresponding input box. According to the processing of steps S144 through S146, the CPU 30 receives an instruction input from the mouse 20 for modification of the entry in one of the input boxes included in the individual setting dialog box DB2 and enters the modified information in the input box.

When it is determined at step S145 that the mouse input received at step S144 represents a click of the ‘OK’ button BT2, on the other hand, the CPU 30 stores the various pieces of setting information, which are displayed in the individual setting dialog box DB2, in the form of the update data file Df1 mapped to the document as the print object, that is, the document currently opened by the application program, on the RAM 32 at step S240. After execution of step S210, the program goes to ‘Return’ and exits from this individual setting routine.

In the case where the document is stored in an external storage device like the HDD 42, the update data file Df1 is also stored in mapping to the document in the external storage device. In the structure of this embodiment, all the pieces of setting information displayed in the individual setting dialog box DB2 are stored in the update data file Df1. In one modified structure, only specified items of the setting information may be stored in the update data file Df1. In this modified structure, the processing of step S220 enters the pieces of setting information stored in the update data file Df1 into the input boxes of the specified items, while entering the other pieces of setting information stored in the setting information storage data file Dev into the input boxes of the other items. This modified structure enables the modification at the time of a previous printing operation to be reflected on only the entries in the input boxes of the specified items.

In the case of an affirmative answer at step S230, that is, in the case of a click of the ‘Reset to Default’ button BT1, the CPU 30 enters the various pieces of setting information, which are stored in the setting information storage data file Dev read at step S141, into the respective input boxes included in the individual setting dialog box DB2 (step S250). As a result of the processing of step S250, the pieces of setting information stored in the setting information storage data file Dev are displayed in the respective input boxes including the input fields, the radio buttons, and the check boxes. After execution of step S250, the CPU 30 goes back to step S144 to receive another mouse input on the individual setting dialog box DB2.

Referring back to FIG. 5, on conclusion of the individual setting routine, the program terminates the processing of step S140 and goes to step S150. In the case of a negative answer at step S130, the CPU 30 skips the individual setting routine of step S140 and directly goes to step S150. The CPU 30 determines at step S150 whether or not a print instruction is given, that is, whether or not an ‘OK’ button is clicked on the ‘Print’ dialog box.

In the case of an affirmative answer at step S150, the program goes to step S160, at which the CPU 30 carries out a printing process to print the document as the print object, that is, the document currently opened by the application program. In the presence of the update data file Df1 mapped to the document, the printing process prints the document according to the setting information of the update data file Df1. In the absence of the update data file Df1 mapped to the document, on the other hand, the printing process reads the setting information in the storage of the setting information storage data file Dev from the RAM 32 and prints the document according to the read-out setting information. The procedure of printing reads the various pieces of setting information from the setting information storage data file Dev and carries out a printing operation according to the read-out pieces of setting information as execution information. When there is the update data file Df1 mapped to the document, the procedure updates the execution information based on the contents of the update data file Df1, which is created from the entries in the respective input boxes of the individual setting dialog box DB2, and thus prints the document according to the setting information of the update data file Df1. Such printing process is known in the art, and the CPU 30 makes document data subjected to color correction, halftoning, and other required series of processing, based on the setting information. This ensures printing of a high-quality image based on desired setting information.

After execution of the printing process at step S160, the program goes to ‘Return’ and exits from this control routine. In the case of a negative answer at step S150, that is, in the case of no input of a print instruction, the program directly goes to ‘Return’ and exits from this control routine.

The processing of steps S110 and S120 in this control routine corresponds to the printer setting module 57 (see FIG. 2) described previously, while the processing of steps S130 through S160 corresponds to the print control module 58 (FIG. 2). More specifically, the processing of step S142 in the individual setting routine corresponds to the data input window display sub-module 58a (FIG. 2). The processing of steps 144 through S146 corresponds to the input reception sub-module 58b (FIG. 2). The processing of steps S150 and S160 correspond to the printer settings change sub-module 58c (FIG. 2), the processing of step S230 corresponds to the specific operation reception sub-module 58d (FIG. 2), and the processing of step S250 corresponds to the input box restoration sub-module 58e.

C. Functions and Effects

In the computer system of the first embodiment constructed as discussed above, the operator enters data in the input boxes of the individual setting dialog box DB2 in the printing process according to the application program. Such entry updates the settings in the setting information storage data file Dev provided in the operating system and enables the printer to perform a printing operation according to the updated information. In response to a click of the ‘Reset to Default’ button BT1 on the individual setting dialog box DB2, the entries in the input boxes of the individual setting dialog box DB2 are restored to the initial setting information read from the setting information storage data file Dev.

The operator may specify desired settings, for example, frequently used settings, for the contents of the setting information storage data file Dev provided in the operating system. This arrangement enables the current settings to be restored to the operator's desired settings by only a simple click of the ‘Reset to Default’ button BT1.

D. Modifications The structure of the first embodiment may be modified in various ways.

(1) In the structure of the above embodiment, the ‘Reset to Default’ button BT1 is provided on the individual setting dialog box DB2 as the specific operation reception sub-module. One modified structure of the specific operation reception sub-module receives a specific key input ([Ctrl]+[Shift]+[S]) on the keyboard 18.

(2) In response to a click of the ‘Reset to Default’ button BT1, the procedure of the above embodiment enters the various pieces of setting information, which are stored in the setting information storage data file Dev read at step S141, into all the input boxes of the individual setting dialog box DB2. One modified procedure enters only specified items of the setting information, which is stored in the setting information storage data file Dev, into the input boxes of the specified items in the individual setting dialog box DB2.

(3) In the structure of the above embodiment, the ‘Reset to Default’ button BT1 is not present on the default setting dialog box DB1 but is provided only on the individual setting dialog box DB2. In one modified structure, the ‘Reset to Default’ button BT1 may be provided on both the dialog boxes DB1 and DB2. The default setting dialog box DB1 is used to update the setting information storage data file Dev. The ‘Reset to Default’ button BT1 is thus actually not required on the default setting dialog box DB1. But the modified structure enables the default setting dialog box DB1 and the individual setting dialog box DB2 to share the major part of the design and thus desirably saves the labor and time of development.

(4) The procedure of the above embodiment creates the update data file Df1 in the individual setting routine and allows the current settings of printer properties with regard to one document to be applied for printing of the identical document at subsequent times. One modified procedure does not create the update data file Df1 and does not allow the current settings of printer properties with regard to one document to be applied for printing of the identical document at subsequent times. The modified procedure is attained by omitting steps S200, S210, and S220 of FIG. 8 and step S240 of FIG. 9.

(5) In the structure of the above embodiment, the ‘Main’, the ‘Layout’, and ‘Options’ tabs included in the default setting dialog box DB1 have similar designs to those of the ‘Main’, the ‘Layout’, and ‘Options’ tabs included in the individual setting dialog box DB2. But this is not essential, and these tabs may have different designs.

A second embodiment of the present invention is discussed below.

E. Construction of System

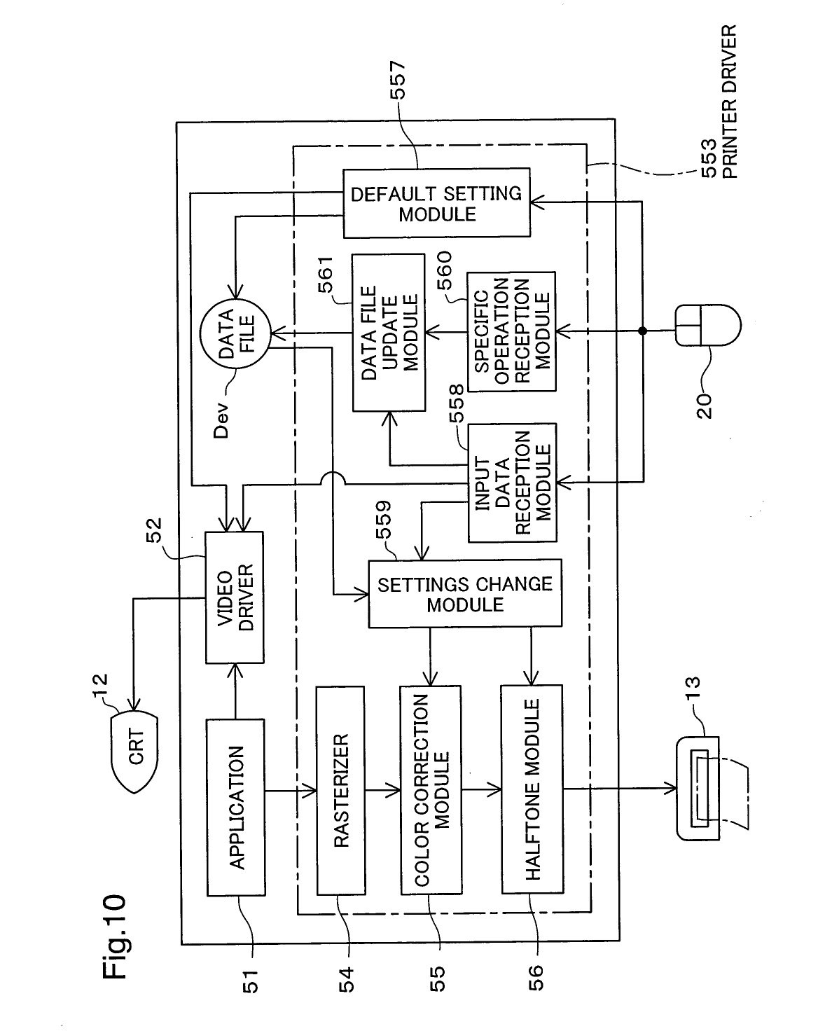

The hardware construction of a computer system in the second embodiment of the invention is identical with that of the first embodiment. In the hardware structure of the second embodiment, the same constituents as those of the first embodiment are expressed by the same numerals. The following describes a printing procedure by the computer system of the second embodiment. FIG. 10 is a block diagram showing a series of processing to print an image based on image information processed by the computer main body 16. As illustrated, an application program 51 running in the computer main body 16 carries out a required series of image processing and displays each processed image on the display 12 via a video driver 52. When the application program 51 issues a print command, a printer driver 553 in the computer main body 16 receives image data from the application program 51 and converts the input image data into signals printable by the printer 13. The printer driver 553 is different from the printer driver of the first embodiment.

In the illustrated example of FIG. 10, the printer driver 553 includes a rasterizer 54 that converts the image data processed by the application program 51 into color information of a dot unit, a color correction module 55 that makes the image data converted into the color information of the dot unit (tone data) subjected to color correction according to the color characteristics of the printer 13, and a halftone module 56 that generates halftone image information, which expresses a density in a certain area by the presence or absence of ink dots based on the color-corrected image data. The rasterizer 54, the color correction module 55, and the halftone module 56 are identical with those of the first embodiment. The same constituents as those of the first embodiment are expressed by the same numerals.

The printer driver 553 also has a default setting module 557, which presets various pieces of information required for printing by the printer 13 and stores the variety of preset pieces of information in a data file (a setting information storage data file discussed later) Dev. The default setting module 557 displays a window via the video driver 52 in response to a given operation on the operating system, and carries out setting of the various pieces of information based on output signals from the mouse 20. The various pieces of information required for printing include the printing quality, the color correction, the process of halftoning, the type and the size of paper, and the printing orientation. Information on the color correction stored in the data file Dev by the Default setting module 57 is sent to the color correction module 55, whereas information on the process of halftoning is sent to the halftone module 56.

The printer driver 553 also includes an input data reception module 558, a settings change module 559, a specific operation reception module 560, and a data file update module 561. The input data reception module 558 opens a data input window on the display 12 via the video driver 52 to receive input data on the data input window through operations of the mouse 20 (and the keyboard 18 when necessary). The settings change module 559 modifies various pieces of information read from the data file Dev, based on the received input data. Information on the color correction included in the modified pieces of information is sent to the color correction module 55, whereas information on the process of halftoning is sent to the halftone module 56.

The specific operation reception module 560 receives a specific operation of the mouse 20 on the data input window. In response to the received specific operation, the data file update module 561 updates the data file Dev, based on the input data received by the input data reception module 558.

As described previously, the printer driver 553 can perform two different procedures of printer setting, that is, default setting applied to all the documents to be printed by the printer 13 and individual setting applied to only a document to be printed at the time of setting. The default setting is implemented according to the following series of operations, as described previously. Here it is assumed that the operating system is Windows 98. The operator first clicks a ‘Start’ button on the screen of the display 12, points an option ‘Settings’, and clicks an option ‘Printer’ to open a ‘Printer’ folder. The operator then right clicks an icon of the printer 13 used for printing among icons displayed in the ‘Printer’ folder to display a dialog box for printer properties (hereafter referred to as default setting dialog box). The ‘Printer’ folder may alternatively be opened by click operations of an icon ‘My Computer’ and the option ‘Printer’.

The default setting dialog box for printer properties of the second embodiment is identical with the default setting dialog box DB1 for printer properties of the first embodiment described previously with reference to FIG. 3. Hereafter, the dialog box of the second embodiment is also called the default setting dialog box DB1.

The other procedure of printer setting, the individual setting, is implemented according to the following series of operations, as discussed previously. Here it is assumed that the photo retouching software is used as the application program to print a processed image. The operator clicks an option ‘Files’ on a menu bar of an application window and subsequently clicks an option ‘Print’ to open a ‘Print’ dialog box. The operator then clicks an ‘Properties’ button in the ‘Printer’ dialog box to open a dialog box for printer properties (this corresponds to the data input window of the present invention and is hereafter referred to as individual setting dialog box).

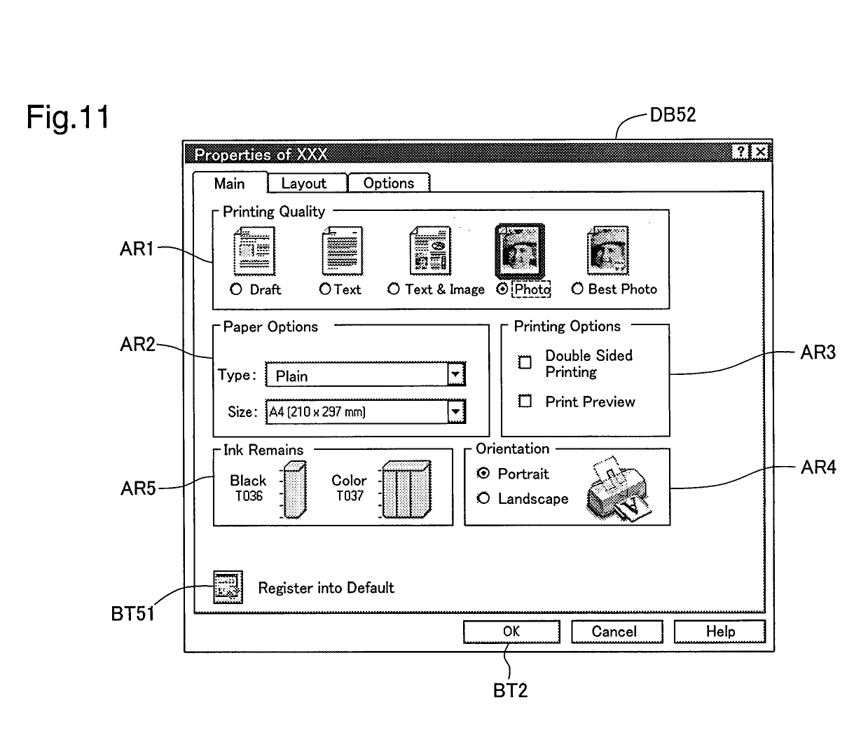

FIG. 11 shows an individual setting dialog box DB52 for printer properties in the second embodiment. As illustrated, the individual setting dialog box DB52 is similar to the individual setting dialog box DB2 of the first embodiment, except that the ‘Reset to Default’ button BT1 is replaced by a ‘Register into Default’ button BT51. A series of processing executed in response to a click of the ‘Register into Default’ button BT51 will be discussed later. The operator inputs data into data input boxes (including radio buttons and check boxes) of the respective tabs on the individual setting dialog box DB52 through operations of the mouse 20 (and the keyboard 18 when necessary). This individual setting dialog box DB52 is displayed by the function of the input data reception module 558.

F. Computer Processing

The CPU 30 of the computer main body 16 executes the printer driver 553 to actualize the respective modules 54 through 56 and 557 through 561. A print control routine executed according to the printer driver 553 is discussed below.

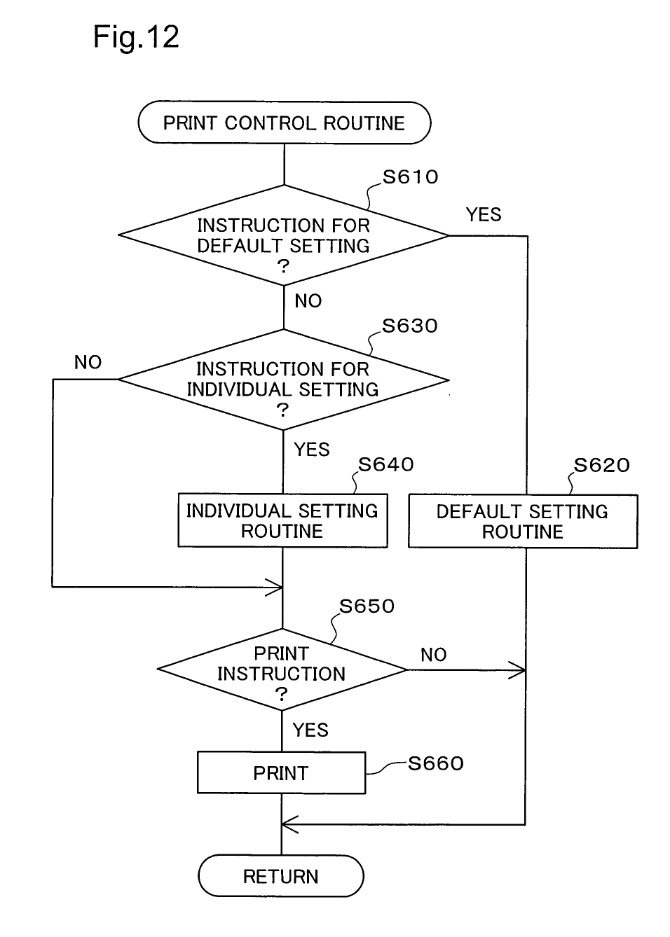

FIG. 12 is a flowchart showing the print control routine. This control routine is repeatedly executed at preset time intervals. When this control routine starts, the CPU 30 first determines whether or not there is input of an instruction for default setting (that is, activation of the printer properties starting from a click of the ‘Start’ button as described previously) (step S610). This instruction is input from the operating system. In the case of an affirmative answer, a default setting routine is activated (step S620).

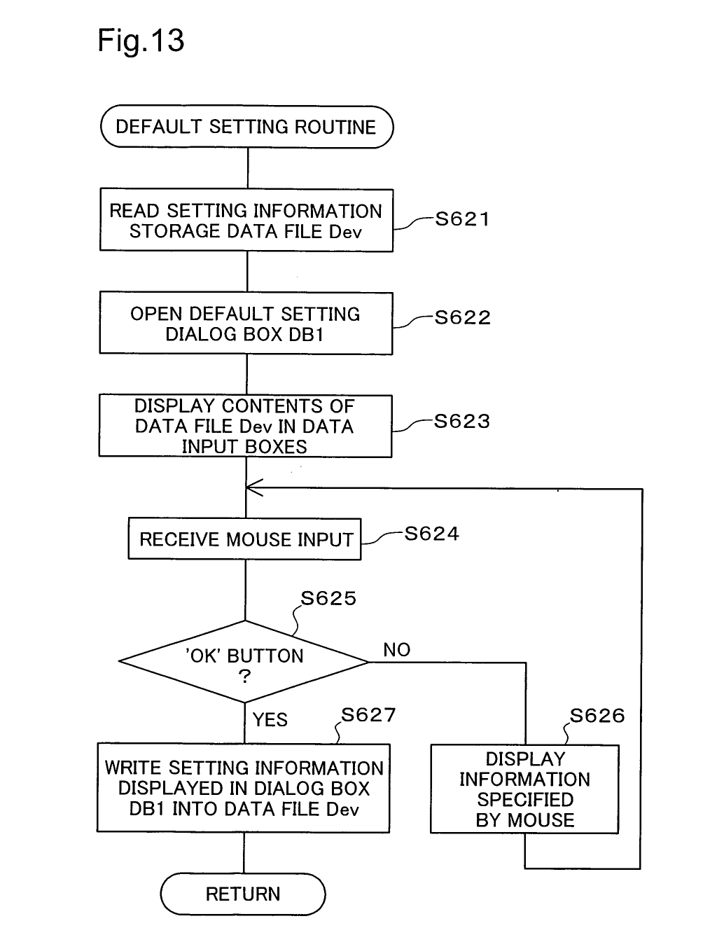

FIG. 13 is a flowchart showing the details of the default setting routine executed at step S620. The series of processing executed by the CPU 30 according to this default setting routine corresponds to the default setting module 557 (see FIG. 10) discussed previously. When the default setting routine starts, the CPU 30 first reads various pieces of setting information from the setting information storage data file Dev stored in the RAM 32 (step S621). The setting information storage data file Dev is included in a registry stored in the operating system. In the case of Windows 98, this data file Dev corresponds to a file ‘¥Printers¥<Printer Name>¥Default Dev Mode’. The setting information storage data file Dev initially has storage of setting information as the basis provided in advance at the time of installation of the printer driver and is updated by a later step of the default setting routine. Like the printer driver, the setting information storage data file Dev is loaded from the HDD 42 into a predetermined area of the RAM 32 in response to activation of the operating system, and is saved from the RAM 32 into the HDD 42 in response to termination of the operating system.

The setting information storage data file Dev has the data structure identical with that of the setting information storage data file Dev of the first embodiment (see FIG. 7).

The CPU 30 then opens the default setting dialog box DB1 on the display 12 (step S622). The CPU 30 subsequently displays the various pieces of setting information read at step S621 in blanks of the data input boxes (including radio buttons and check boxes) on the default setting dialog box DB1 (step S623). As a result of the processing of steps S622 and S623, the default setting dialog box DB1 opened on the display 12 has entries of the setting information, which is stored in the setting information storage data file Dev, in the respective data input boxes, radio buttons, and check boxes.

The CPU 30 then receives an input from the mouse 20 on the open default setting dialog box DB1 (step S624), and determines whether or not the mouse input received at step S624 represents a click of the ‘OK’ button BT2 (step S625). In the case of a negative answer, the CPU 30 displays a piece of information specified by the mouse input received at step S624 in the corresponding data input box. According to the processing of steps S624 through S626, the CPU 30 receives an instruction input from the mouse 20 for modification of the entry in one of the data input boxes (including radio buttons and check boxes) on the default setting dialog box DB1 and enters the modified information in the input box. After execution of step S626, the CPU 30 goes back to step S624 to receive another mouse input on the default setting dialog box DB1.

In the case of an affirmative answer at step S625, that is, when it is determined that the mouse input received at step S624 represents a click of the ‘OK’ button BT2, on the other hand, the CPU 30 writes the various pieces of setting information, which are displayed in the default setting dialog box DB1, into the setting information storage data file Dev of the RAM 32, so as to update the setting information storage data file Dev at step S627. After execution of step S627, the program goes to ‘Return’ and exits from this default setting routine.

Referring back to FIG. 12, on conclusion of the default setting routine, the program goes to ‘Return’ and exits from the print control routine. In the case of a negative answer at step S610, on the other hand, the CPU 30 determines whether or not there is input of an instruction for individual setting (that is, activation of the printer properties on the ‘Print’ dialog box as described previously) at step S630. This instruction is input from the application program via the operating system. In the case of an affirmative answer, an individual setting routine is activated (step S640).

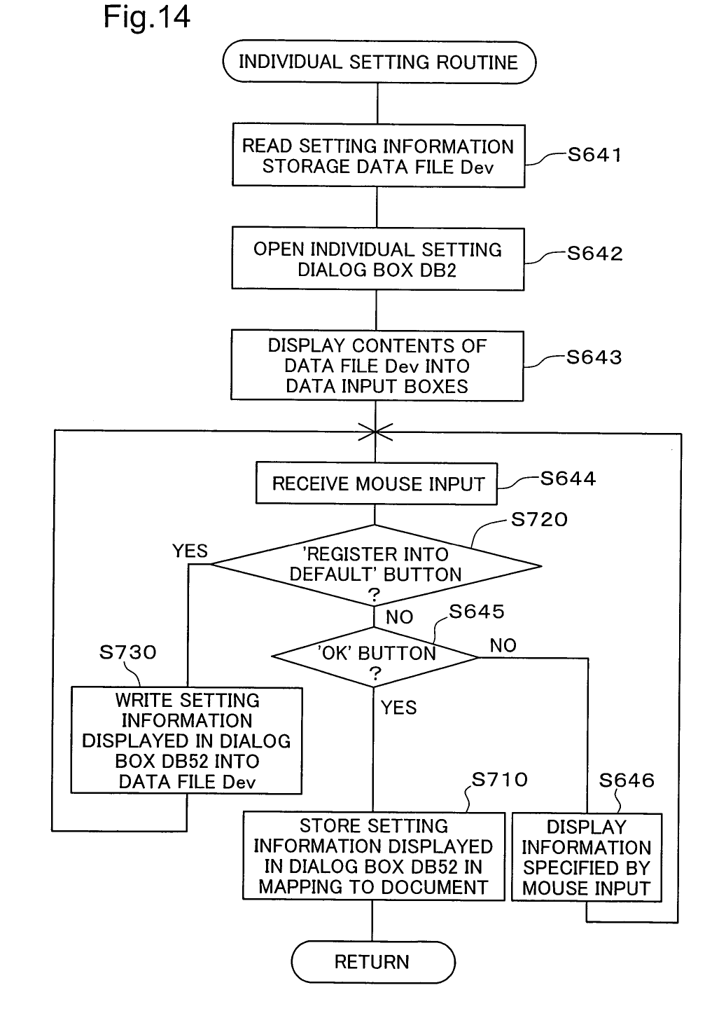

FIG. 14 is a flowchart showing the details of the individual setting routine executed at step S640. The individual setting routine executes the processing of steps S641 through S646, which is similar to the processing of steps S621 through S626 of the default setting routine discussed above. The differences of the processing of steps S641 through S646 from the corresponding steps of the default setting routine are that the individual setting dialog box DB52 is open on the display 12, in place of the default setting dialog box DB1, and that the individual setting dialog box DB52 is the object of entries of the setting information stored in the setting information storage data file Dev and the mouse input.

In the case of an affirmative answer at step S645, on the other hand, the CPU 30 maps the various pieces of setting information, which are displayed on the individual setting dialog box DB52, to the document as the print object, that is, the document currently opened by the application program, and stores the mapping on the RAM 32 at step S710. After execution of step S710, the program goes to ‘Return’ and exits from this individual setting routine.

Decision of step S720 is carried out between steps S644 and S645. At step S720, the CPU 30 determines whether or not the mouse input received at step S644 represents a click of the ‘Register into Default’ button BT 51 provided on the individual setting dialog box DB52. In the case of a negative answer, the program goes to step S645. In the case of an affirmative answer at step S720, that is, when it is determined that the mouse input represents a click of the ‘Register into Default’ button BT51, on the other hand, the CPU 30 writes the various pieces of setting information, which are displayed in the individual setting dialog box DB52, into the setting information storage data file Dev of the RAM 32, so as to update the setting information storage data file Dev (step S730).

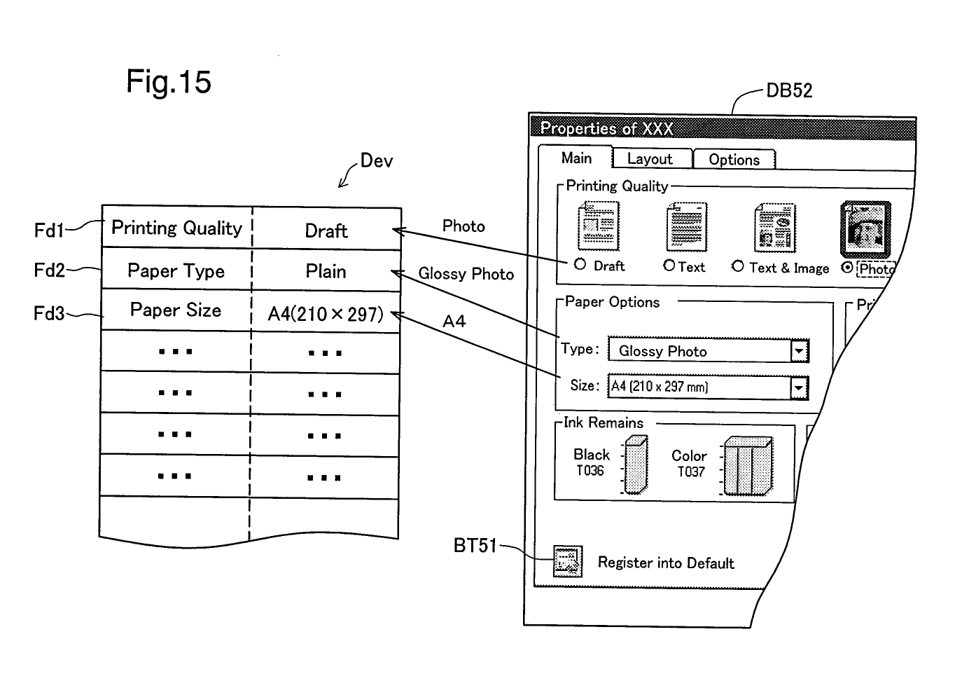

FIG. 15 schematically shows the processing of step S730. In the illustrated example, the option ‘Photo’ is selected in the ‘Printing Quality’ input area AR1, and the type ‘Glossy Photo’ and the size ‘A4 210×297 mm’ are selected in the ‘Paper Options’ input area AR2 in the individual setting dialog box DB52. In this state, in response to a click of the ‘Register into Default’ button BT51, the entries of the setting information in the individual setting dialog box DB52, for example, data representing the selected printing quality ‘Photo’, data representing the selected paper type ‘Glossy Photo’, and data representing the selected paper size ‘A4 210×297 mm’, are overwritten on the setting information storage data file Dev. In the structure of the embodiment, all the pieces of setting information input in the individual setting dialog box DB52 are overwritten on the corresponding entries of the setting information storage data file Dev, regardless of the actual modification. One modified structure may overwrite only modified entries.

Referring back to FIG. 14, after execution of step S730, the CPU 30 goes back to step S644 to receive another mouse input on the individual setting dialog box DB52. In the individual setting routine, the processing of steps S642, S643, and S644 corresponds to the input data reception module 558 (FIG. 10) described previously, while the processing of step S710 corresponds to the settings change module 559 (FIG. 10). The processing of steps S644 and S720 corresponds to the specific operation reception module 560 (FIG. 10), and the processing of step S730 corresponds to the data file update module 561.

Referring back to FIG. 12, on conclusion of the individual setting routine, the program terminates the processing of step S640 and goes to step S650. In the case of a negative answer at step S630, the CPU 30 skips the individual setting routine of step S640 and directly goes to step S650. The CPU 30 determines at step S650 whether or not a print instruction is given, that is, whether or not the ‘OK’ button is clicked on the ‘Print’ dialog box.

In the case of an affirmative answer at step S650, the program goes to step S660, at which the CPU 30 carries out a printing process to print the document as the print object, that is, the document currently opened by the application program. In the presence of the setting information mapped to the document (that is, when the setting information has been stored at step S710 in the individual setting routine), the printing process prints the document according to the mapped setting information. In the absence of the setting information mapped to the document, on the other hand, the printing process reads the setting information in the storage of the setting information storage data file Dev from the RAM 32 and prints the document according to the read-out setting information. Such printing process is known in the art, and the CPU 30 makes document data subjected to color correction, halftoning, and other required series of processing, based on the various pieces of setting information specified by default setting or based on the various pieces of setting information modified at the time of printing by the application program. This ensures printing of a high-quality image based on desired setting information.

After execution of the printing process at step S660, the program goes to ‘Return’ and exits from this control routine. In the case of a negative answer at step S650, that is, in the case of no input of a print instruction, the program directly goes to ‘Return’ and exits from this control routine.

G. Functions and Effects

In the computer system of the second embodiment constructed as discussed above, in response to a click of the ‘Register into Default’ button BT51 on the dialog box (individual setting dialog box) DB52 for printer properties, which is opened at the time of printing a document by the application program, the setting information storage data file Dev is updated with the entries of the setting information on the individual setting dialog box DB52.

The setting information storage data file Dev is updated by activation of the printer properties starting from a click of the ‘Start’ button of the operating system. In order to apply the setting information input on the individual setting dialog box DB52 to other documents, the prior art procedure should close the individual setting dialog box DB52 and re-click the ‘Start’ button to re-activate the printer properties. In the computer system of this embodiment, however, the setting information storage data file Dev is updatable by a simple click of the ‘Register into Default’ button BT51. The desired printer settings at the time of printing a certain document are thus applicable to printing of other documents through the simple operation.

H. Modifications

The structure of the second embodiment may be modified in various ways.

(1) In the structure of the above embodiment, the ‘Register into Default’ button BT51 is provided on the individual setting dialog box DB52 as the specific operation reception module. One modified structure of the specific operation reception module receives a specific key input ([Ctrl]+[Shift]+[S]) on the keyboard 18.

(2) In the structure of the above embodiment, the ‘Register into Default’ button BT51 is not present on the default setting dialog box DB1 but is provided only on the individual setting dialog box DB52. In one modified structure, the ‘Register into Default’ button BT51 may be provided on both the dialog boxes DB1 and DB52. The default setting dialog box DB1 is used to update the setting information storage data file Dev. The ‘Register into Default’ button BT51 is thus actually not required on the default setting dialog box DB1. But the modified structure enables the default setting dialog box DB1 and the individual setting dialog box DB52 to share the major part of the design and thus desirably saves the labor and time of development.

(3) In the structure of the above embodiment, the ‘Main’, the ‘Layout’, and ‘Options’ tabs included in the default setting dialog box DB1 have similar designs to those of the ‘Main’, the ‘Layout’, and ‘Options’ tabs included in the individual setting dialog box DB52. But this is not essential, and these tabs may have different designs.

The computer systems, the printer setting methods, and the computer readable media of the present invention are described above on the grounds of the embodiments. These embodiments are, however, to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The scope and spirit of the present invention are indicated by the appended claims, rather than by the foregoing description.

What is claimed is:

1. A computer apparatus for printer setting, said computer apparatus connecting with a display device, a printer, and an input device manipulated by an operator and having an operating system and an application program incorporated therein, said computer apparatus comprising:
a printer setting module that sets various pieces of information required for printing with said printer and stores settings of the various pieces of information in a predetermined data file, according to the operating system; and
a print control module that reads the settings of the various pieces of information from the predetermined data file as execution information and causes said printer to execute a printing operation based on the execution information, according to the application program,
said print control module comprising:
a data input window display module that, in response to a given operation of said input device, displays a data input window, which includes multiple input boxes corresponding to the various pieces of information, with preset entries of default data in the respective input boxes on said display device;
an input reception module that enters data input from said input device into at least one of the input boxes of the data input window;
a printer settings change module that modifies the execution information, based on the data entered into at least one of the input boxes of the data input window;
a specific operation reception module that receives a specific operation of said input device on the data input window; and
an input box restoration module that, when said specific operation reception module receives the specific operation, enters data based on the settings of the various pieces of information read from the predetermined data file, into the input boxes of the data input window.

2. A computer apparatus for printer setting in accordance with claim 1, wherein said specific operation reception module receives a click of a preset button provided on the data input window.

3. A computer apparatus for printer setting in accordance with either one of claims 1 and 2, wherein the default data preset in the multiple input boxes of the data input window are data based on the settings of the various pieces of information read from the predetermined data file.

4. A computer apparatus for printer setting, said computer apparatus connecting with a display device, a printer, and an input device manipulated by an operator and having an operating system and an application program incorporated therein, said computer apparatus comprising:
a default setting module that sets various pieces of information required for printing with said printer and stores settings of the various pieces of information in a predetermined data file, according to the operating system; and
a print control module that reads the settings of the various pieces of information from the predetermined data file and causes said printer to execute a printing operation based on the read-out pieces of information, according to the application program,
said print control module comprising:
an input data reception module that, in response to a given operation of said input device, displays a data input window on said display device to receive input data from said input device on the data input window;
a settings change module that modifies the settings of the various pieces of information read from the predetermined data file, based on the input data received by said input data reception module, so as to change over printing conditions;
a specific operation reception module that receives a specific operation of said input device on the data input window; and
a data file update module that, when said specific operation reception module receives the specific operation, updates the predetermined data file, based on the input data received by said input data reception module.

5. A computer apparatus for printer setting in accordance with claim 4, wherein said specific operation reception module receives a click of a preset button provided on the data input window.

6. A print control method that is related to series of processing according to an application program and an operating system that controls at least operations of a display device, a printer, and an input device manipulated by an operator, said print control method thereby causing said printer to carry out a printing operation, said print control method comprising the steps of:
(a) setting various pieces of information required for printing with said printer and storing settings of the various pieces of information in a predetermined data file, according to the operating system; and
(b) reading the settings of the various pieces of information from the predetermined data file as execution information and causing said printer to execute a printing operation based on the execution information, according to the application program,
said step (b) comprising the steps of:
(b-1) in response to a given operation of said input device, displaying a data input window, which includes multiple input boxes corresponding to the various pieces of information, with preset entries of default data in the respective input boxes on said display device;
(b-2) entering data input from said input device into at least one of the input boxes of the data input window;
(b-3) modifying the execution information, based on the data entered into at least one of the input boxes of the data input window;
(b-4) receiving a specific operation of said input device on the data input window; and
(b-5) when the specific operation is received in said step (b-4), entering data based on the settings of the various pieces of information read from the predetermined data file, into the input boxes of the data input window.

7. A print control method in accordance with claim 6, wherein said step (b-4) receives a click of a preset button provided on the data input window.

8. A print control method that is related to series of processing according to an application program and an operating system that controls at least operations of a display device, a printer, and an input device manipulated by an operator, said print control method thereby causing said printer to carry out a printing operation, said print control method comprising the steps of:
(a) setting various pieces of information required for printing with said printer and storing settings of the various pieces of information in a predetermined data file, according to the operating system; and
(b) reading the settings of the various pieces of information from the predetermined data file and causing said printer to execute a printing operation based on the read-out pieces of information, according to the application program,
said step (b) comprising the steps of:
(b-1) in response to a given operation of said input device, displaying a data input window on said display device to receive input data from said input device on the data input window;
(b-2) modifying the settings of the various pieces of information read from the predetermined data file, based on the input data received in said step (b-1), so as to change over printing conditions;
(b-3) receiving a specific operation of said input device on the data input window; and
(b-4) when the specific operation is received in said step (b-3), updating the predetermined data file, based on the input data received in said step (b-1).

9. A print control method in accordance with claim 8, wherein said step (b-3) receives a click of a preset button provided on the data input window.

10. A computer readable medium, in which a program command is stored, said program command being related to series of processing according to an application program and an operating system that controls at least operations of a display device, a printer, and an input device manipulated by an operator, said program command thereby controlling said printer, said program command comprising:
a first program command that sets various pieces of information required for printing with said printer and stores settings of the various pieces of information in a predetermined data file, according to the operating system; and
a second program command that reads the settings of the various pieces of information from the predetermined data file as execution information and causes said printer to execute a printing operation based on the execution information, according to the application program,
said second program command comprising:
a third program command that display module that, in response to a given operation of said input device, displays a data input window, which includes multiple input boxes corresponding to the various pieces of information, with preset entries of default data in the respective input boxes on said display device;
a fourth program command that enters data input from said input device into at least one of the input boxes of the data input window;
a fifth program command that modifies the execution information, based on the data entered into at least one of the input boxes of the data input window;
a sixth program command that receives a specific operation of said input device on the data input window; and
a seventh program command that, when said sixth program command receives the specific operation, enters data based on the settings of the various pieces of information read from the predetermined data file, into the input boxes of the data input window.

11. A computer readable medium in accordance with claim 10, wherein said sixth program command receives a click of a preset button provided on the data input window.

12. A computer readable medium in accordance with either one of claims 10 and 11, wherein the default data preset in the multiple input boxes of the data input window are data based on the settings of the various pieces of information read from the predetermined data file.

13. A computer readable medium, in which a program command is stored, said program command being related to series of processing according to an application program and an operating system that controls at least operations of a display device, a printer, and an input device manipulated by an operator, said program command thereby controlling said printer, said program command comprising:
a first program command that sets various pieces of information required for printing with said printer and stores settings of the various pieces of information in a predetermined data file, according to the operating system; and
a second program command that reads the settings of the various pieces of information from the predetermined data file and causes said printer to execute a printing operation based on the read-out pieces of information, according to the application program,
said second program command (b) comprising:
a third program command that, in response to a given operation of said input device, displays a data input window on said display device to receive input data from said input device on the data input window;
a fourth program command that modifies the settings of the various pieces of information read from the predetermined data file, based on the input data received by said first program command (b-1), so as to change over printing conditions;
a fifth program command that receives a specific operation of said input device on the data input window; and
a sixth program command that, when said fifth program command receives the specific operation, updates the predetermined data file, based on the input data received by said third program command.

14. A computer readable medium in accordance with claim 13, wherein said fifth program command receives a click of a preset button provided on the data input window.
